(19) United States
(12) Patent Application Publication
(10) Pub. No.: US 2013/0198031 A1
(43) Pub. Date: Aug. 1, 2013

(54) METHOD AND SYSTEM FOR OPTIMUM ROUTING

(71) Applicants: Guy Mitchell, (US); Nayan Bhagwanji Ruparelia, Watford Herts (GB)

(72) Inventors: Guy Mitchell, (US); Nayan Bhagwanji Ruparelia, Watford Herts (GB)

(21) Appl. No.: 13/360,076

(22) Filed: Jan. 27, 2012

(51) Int. Cl. G01C 21/34; G06Q 30/00

(52) U.S. Cl. 705/26.8; 701/408; 701/468

(57) ABSTRACT

Embodiments of the present invention disclose a method and system for optimum routing on a vehicle equipped with a global positional system device. According to one embodiment, a current location of the vehicle is determined and a travel destination is predicted based upon stored travel information. Furthermore, an optimum route of travel between the current location and the predicted travel destination is calculated based upon sensor information and the distance between the current location and the predicted destination.

### BACKGROUND

Advancements in navigation technology have made global positioning systems (GPS) a staple in today's marketplace. Today, GPS navigation systems are omnipresent and operable as standalone devices, applications on mobile phones, and as onboard vehicle systems. GPS systems are generally used to provide routing information between two identified points of interest. Typically, a user enters a particular destination into the GPS system and a preferred route is determined. More modern devices are configured to account for real-time traffic conditions in determining the preferred route. These GPS systems still heavily rely on manual entry or input from the user, which is often a burdensome and time-consuming task.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of the optimum routing system in accordance with an example of the present invention.

FIG. 2 is a simplified flow chart of a method of calculating an optimum route according to an example of the present invention.

FIG. 3 is another simplified flow chart of a method of calculating an optimum route according to an example of the present invention.

FIG. 4 is another simplified flow chart of a method of calculating an optimum route according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

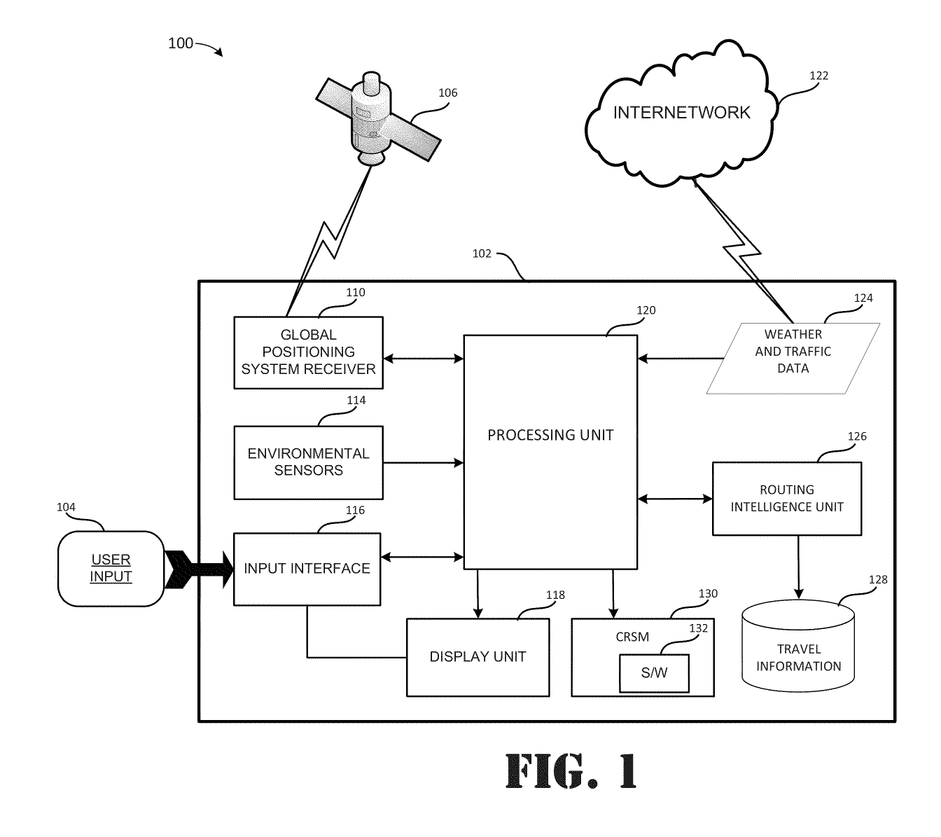

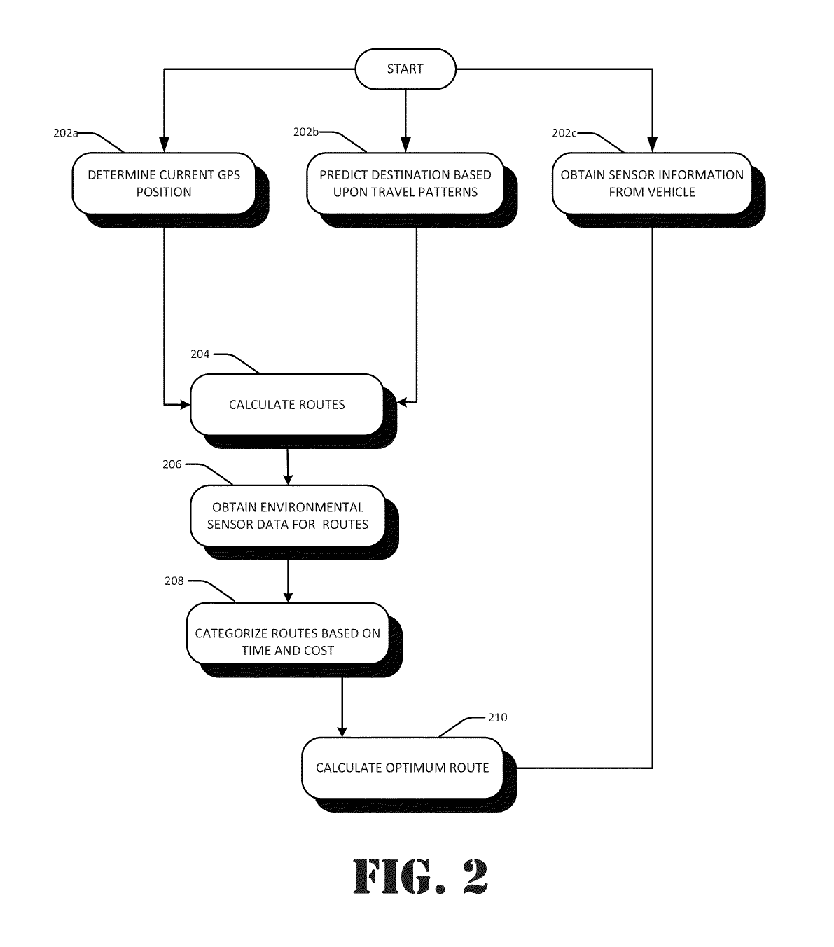

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Typically, GPS systems only provide the positional or location information associated with the GPS-enabled device or vehicle. Some GPS systems include storage databases for storing and displaying points of interest along a current route (e.g., gas station, court house, shopping mall). More advanced GPS systems use aspects of business intelligence (BI) to inform an operating user of approaching items based on current events. However, there is still a need in the art for a more automated, useful, and user-friendly approach to determining the preferred or optimized navigational route for drivers and GPS systems alike.

When driving or traveling along a route, most people follow distinct travel patterns such that these travel patterns usually become repetitive and thus recognizable. Moreover, modern motor vehicles include a number of sensors for indicating gasoline usage, tire pressure, and oxygen levels for example. These sensors aid in alerting an operating user when the vehicle needs servicing or that the vehicle will be negatively impacted if driven in its current condition. Furthermore, the combined effect of the sensor readings may provide additional insight into a vehicle performance, particularly when considering environmental conditions such as temperature and humidity.

Embodiments of the present invention disclose a method and system for optimum routing for GPS navigational systems. Business intelligence, predictive analysis, and sensor data associated with the motor vehicle and environment are utilized to provide the most optimum route between two identified travel locations. According to one example, historical travel and route information is stored in the system such that a destination can be predicted using the current location and time in addition to the stored travel data. Furthermore, an optimum route of travel is computed based on the sensor information associated with the vehicle and/or environment and a distance between the current location and the predicted destination.

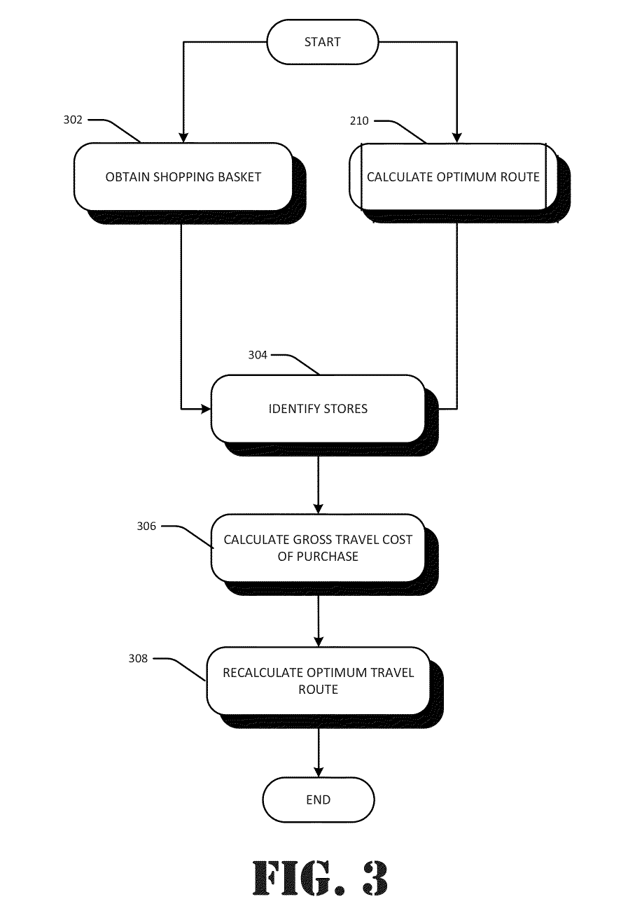

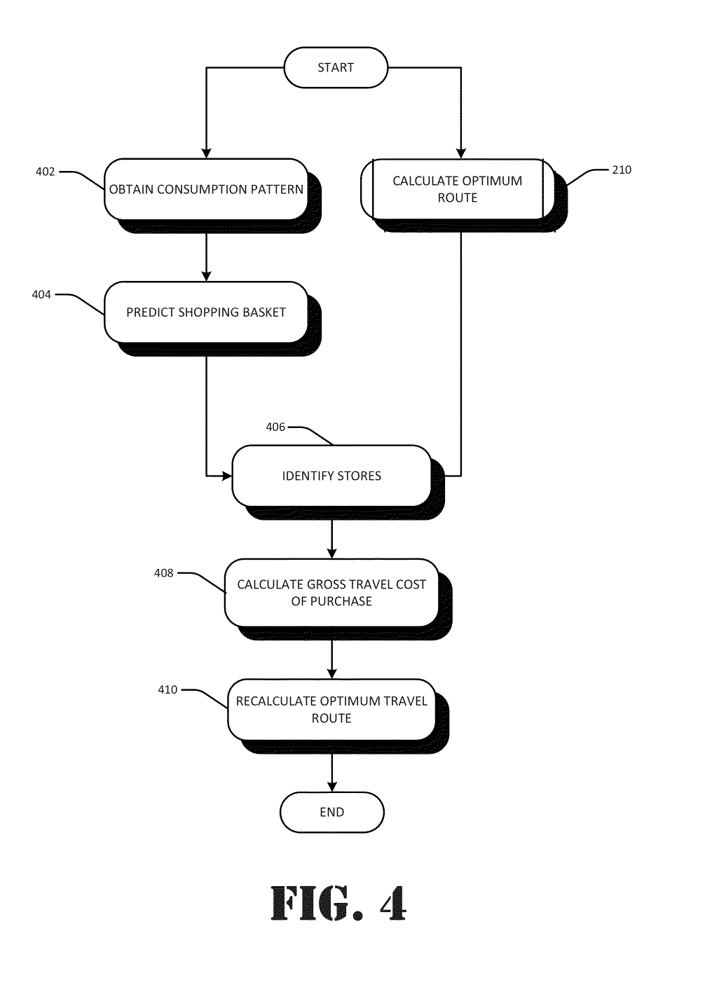

Referring now in more detail to the drawings in which like numerals identify corresponding parts throughout the views, FIG. 1 is a simplified block diagram of the optimum routing system in accordance with an example of the present invention. As shown here, the optimum routing system 100 includes a number of processing components and modules that may implemented on device 102 such as a portable device (e.g., smart phone, stand alone GPS) or motor vehicle. In one embodiment, processing unit 120 represents a central processing unit (CPU), microcontroller, microprocessor, or logic configured to execute programming instructions associated with the optimum routing system 100. More particularly, the processing unit 120 is configured to receive and collect data from other components and process the received data to determine an optimum route of travel. To assist in computational analysis, the processing unit 120 may utilize static data based on industry standards for determining vehicle performance with respect to internal or external vehicle conditions. For example, a vehicle with brand new tires will provide the user twenty percent better gas mileage than a vehicle with extreme tire wear. The processing unit is further configured to utilize the collected data to compute the optimum ‘total cost of purchase’ (as will be described in further detail with respect to the FIGS. 3 and 4) and thereby select the most cost efficient and eco-friendly destination options. The routing intelligence module or unit 126 is configured to analyze and collect the travel patterns associated with the user and device (e.g., vehicle, mobile phone). According to one example embodiment, a set of historical routes including the fuel consumption, travel times, travel duration, costs, etc., are stored in the travel information database 128. The routing intelligence unit is further configure to analyze the travel information to create a set of historical travel patterns having common characteristics (e.g. same day and time; same origin location and target destination). Such a configuration allows the routing system 100 to predict the most viable and optimum route before the journey is actually undertaken. For example, the routing intelligence module 126 may recognize a travel pattern of a user through historical travel routing data corresponding to a current location (e.g., home) to the user's workplace using the same directions Monday through Friday at 8 a.m. but not on Saturday or Sunday (i.e., common characteristics). This travel pattern information is fed into the current processing unit 120. In accordance with one implementation, data collection and usage is obtained via the routing intelligence unit 126 continuously based upon the travel and/or purchase habits and trends of the operating user.

Display unit 128 represents an electronic visual display and touch-sensitive display configured to display images and GPS information to the operating user. The display unit 128 may include a graphical user interface 116 for enabling input interaction 104 (e.g., touch-based) between the user and the computing device 102. Still further, storage medium 130 represents volatile storage (e.g. random access memory), non-volatile store (e.g. hard disk drive, read-only memory, compact disc read only memory, flash storage, etc.), or combinations thereof. Furthermore, storage medium 130 includes software 132 that is executable by processor 120 and, that when executed, causes the processor 120 to perform some or all of the functionality described herein. For example, the routing intelligence unit 126 may be implemented as executable software within the storage medium 130 (e.g., DVD-based navigation), or as replacement for the processing unit 120.

Vehicular and environmental sensors 114 are used for providing external/internal operating and environmental conditions to the processing unit 120. For example, sensors 114 represents sensors for indicating mechanical and/or electrical conditions of the vehicle such as tire pressure sensors, oxygen sensors, fuel sensors and the like for providing information relating to the tire pressure, oxygen, and fuel status respectively, so as inform the system and user about the vehicle's performance. Moreover, environmental sensors for detecting the ambient temperature, pollution levels and the like may also be utilized for providing environmental information to the processing unit 120. For example, tire pressure (PSI) is important because it can affect how a vehicle drives and stops. Excessive tire pressure may cause an uncomfortable drive while too little pressure can cause tire overheating—with either having to potential to lead to a traffic accident. Moreover, changes in the air temperature can affect your tire pressure as tires may either gain or lose one pound of pressure for every 10 degrees in temperature change. The process unit 120 and routing intelligence unit 126 are configured to account for these types of affects on the vehicle's performance when calculating the optimum travel route.

The global positioning receiver 110 is configured to calculate the geographic location of the user or vehicle based on signals received from GPS satellite 122 as will be appreciated by one skilled in the art. More importantly, the GPS receiver 110 is configured to provide the geographical information to the processing unit 120 including the current geographical location of the device 102 and possible destination locations (e.g., if the user desires to obtain a service or product). In addition, real-time weather and traffic feeds 124 (as well as forecasted weather and traffic data) may be obtained from an internetwork 122 or weather satellites/beacon based on the current and/or destination geographical locations, and then read by the processing unit 120.

Once the data is processed by the processing unit 120, the one or more optimum routes may be displayed to the user on a dashboard or display screen 118 associated with the routing system 100. There may also be an option to automatically accept the most cost-efficient option. In addition, the results may be self-learning such that further options are supplied based on the inclusion of new or updated information. According to one example embodiment, the route determination process may be initiated by the user upon entering a command to go to a destination for a particular purpose such as work or shopping for example. Based on the current day and time and travel pattern information from the routing intelligence unit, the processing unit 120 and system 100 can automatically execute the route determination process and provide travel options to the user for initiating the journey.

FIG. 2 is a simplified flow chart of a method of calculating an optimum route according to an example of the present invention. Initially, the routing process determines the current GPS position of the device is in step 202a, along with predicts the destination location using stored travel patterns in step 202b, and obtains sensor information associated with the vehicle or device (e.g., tire pressure). Next, in step 204, a number of routes between the current GPS location of the device and the predicted destination are calculated by the processing unit. Furthermore, environmental sensor data for each of the plurality of routes are obtained in step 206. For example, weather and traffic feeds collected for establishing the conditions of travel along each of the calculated and potential travel routes. According to one example embodiment, in step 208, the calculated routes are then categorized based on the time of travel to the predicted destination and the cost associated with traveling along the route. For example, highway or freeway driving is often faster and consumes less fuel (i.e., better gas mileage) than city or rural driving routes. However, in some cases highway traffic conditions, particularly during rush hour in large metropolitan cities, may dictate a faster or shorter travel along the city or rural route than the highway route. In such a scenario, the routing intelligence unit may weigh the savings in time as more valuable than the slightly higher travel costs (e.g. 20 minute time savings along rural route is greater than nominal fuel consumption savings by traveling along highway route). Thereafter, in step 210, the optimum route is calculated on the basis of the travel time and cost to the predicted destination, the distance from the current position, and the environmental conditions and/or vehicle conditions from the obtained sensor information associated with the travel route and vehicle/device respectively. According to example embodiment, the categorized routes are combined with sensor information to produce the optimum route. For example, vehicle and/or environmental sensor information may reduce the ranking of the categorized routes such that the fastest route is not automatically determined as the most optimum route (e.g., flooding present on highway route may reduce travel time, or current tire pressure/oxygen level will effect snow/high speed travel travel greater on a particular route). As explained above, the destination may be any location such as a retail outlet, workplace, or the like. That is, the most optimum route may be determined based upon time taken to travel and/or the cost of travel to a particular destination.

FIG. 3 is another simplified flow chart of a method of calculating an optimum route according to an example of the present invention. In the present example, shopping basket information 302 is obtained along with the process 210 for calculating the optimum travel route as described above. In one example, the shopping basket includes item(s) sold at retail stores such as groceries, clothes, or similar items. According to one example, the shopping basket information may be uploaded from a user's mobile device or any other storage medium (e.g., on-board memory, personal cloud, etc.). Retail store(s) associated with the obtained shopping basket item(s) are identified in step 304 via the processing unit and internetwork described with respect to FIG. 1. The price of goods or services (i.e., shopping basket items) at identified destination locations or retail store(s) are thereafter obtained by the processing unit or routing intelligence unit such that a comparison can be made for calculating the total costs of travel associated with the purchase, or “gross travel cost of purchase”. In one example, the gross travel cost may be expressed and represented as the sum of the cost of the desired goods or services, the cost of travelling to the location (e.g., fuel consumption), and the time taken to do so. Next, in step 308 of the present example, the optimum travel route is recalculated based upon calculated gross travel cost. Thus, the present configuration enables a routing system that considers the availability of items in a preset shopping basket while also aiding in cost savings by reducing the number of trips to various stores for obtaining all the shopping cart items.

FIG. 4 is a simplified flow chart of a method of determining an optimum route according to an example of the present invention. In step 404, the system is configured to predict a timing for when certain shopping basket items shall be placed in the shopping basket. For example, the travel intelligence module may determine, based upon historical travel patterns and shopping basket items (i.e., consumption pattern), that the user purchases a cart of eggs and loaf of bread once a week. In step 406, the routing system identifies retail store(s) associated with the predicted shopping basket and along the calculated optimum route. Based upon pricing information associated with the retail store(s) and shopping item(s), which may be obtained via the internetwork or manually entered for example, the gross travel cost is calculated in step 408. Consequently, in step 410, an optimum travel route may then be recalculated through analysis of the gross travel cost in order to allocate an optimum time for purchasing shopping items so as to provide the least expensive travel costs. For example, the routing intelligence module may determine that the optimum travel route and timing for purchase of particular grocery items given the vehicle/environment conditions (light traffic in the evening), item availability (items restocked Tuesday morning), and item pricing (local grocery has sale on predicted items), is at the local grocery store on Tuesday evening upon leaving work. Similarly, another implementation of the present examples may involve a retail store (e.g., grocery store) planning or predicting deliveries to customers based upon the customer's location, consumption patterns, and environmental conditions for example.

Examples of the present invention provide a system and method for optimum routing on a GPS-enabled device. Through use of the internal and external sensor and GPS information, predictive analysis can determine numerous routes to a particular destination. In the present example, an optimized route may be suggested to the user based upon knowledge of user's travel patterns, the car's current performance capabilities as provided by the sensors, and its GPS position. Furthermore, numerous advantages are enabled through implementation of the optimum routing intelligence system. For example, effective analysis of the on-board vehicle sensors serves to improve the vehicle's performance thereby reducing fuel consumption while also extending the life of the vehicle. Moreover, the predicted destination and optimum route(s) may be computed and provided to the operating user automatically and without manual input from the user.

Furthermore, while the invention has been described with respect to exemplary embodiments, one skilled in the art will recognize that numerous modifications are possible. For example, although exemplary embodiments describe the routing and GPS system being implemented within a motor vehicle, the invention is not limited thereto. For example, the routing intelligence and GPS system may be implemented on a mobile device, laptop, or any other device configured to transmit and receive GPS information. Thus, although the invention has been described with respect to exemplary embodiments, it will be appreciated that the invention is intended to cover all modifications and equivalents within the scope of the following claims.

What is claimed is:

1. A computer-implemented method for optimum routing for a vehicle, the method comprising:
determining a current location of the vehicle;
predicting a destination based on stored travel information;
obtaining sensor information associated with the vehicle; and
calculating an optimum route of travel based on the obtained sensor information and a distance between the current location and the predicted destination.

2. The method of claim 1, further comprising:
storing a plurality of travel routes associated with operation of the vehicle.

3. The method of claim 1, wherein the step of predicting a location destination further comprises:
analyzing the plurality of travel routes to determine at least one travel pattern, wherein the at least one travel pattern includes common characteristics of travel;
predicting a destination location based on the current location of the vehicle, current time and day information, and the common characteristics of the travel pattern.

4. The method of claim 3, wherein the step of calculating an optimum route of travel further comprises:
determining a plurality of possible travel routes for the predicted destination.

5. The method of claim 4, wherein the step of calculating an optimum route of travel further comprises:
obtaining sensor information associated with the environment at the current location, the predicted destination, and along the plurality of possible travel routes.

6. The method of claim 4, wherein the step of calculating an optimum route of travel further comprises:
calculating a cost of travel for each of the plurality of possible travel routes based on the obtained vehicle sensor information and the environmental sensor information;
categorizing the plurality of possible travel routes based on the cost of travel and a calculated travel time from the current location to the predicted destination.

7. The method of claim 6, further comprising:
obtaining shopping basket information from an operating user, wherein the shopping basket includes at least one shopping item; and
identifying at least one retail store associated with the at least one shopping item; and
recalculating the optimum travel route based on a cost associated with shopping item and a cost of travel from the current location to the retail store associated with said shopping item.

8. The method of claim 6, further comprising:
storing a history of shopping basket information;
analyzing the stored shopping basket history to create a consumption pattern;
predicting a shopping basket including at least one shopping item based on the consumption pattern;
identifying at least one retail store associated with the shopping basket; and
recalculating the optimum travel route based on a cost associated with the shopping item and a cost of travel from the current location to the retail store associated with said shopping item.

9. A system for optimum routing of a vehicle, the system comprising:
a global positioning system (GPS) for providing the current location of the vehicle;
a plurality of vehicle sensors configured to detect sensor information associated with vehicle; and
a routing intelligence module configured to predict a travel destination based on stored travel information;
wherein an optimum route of travel is calculated based on the vehicle sensor information and a distance between the current location and the predicted destination.

10. The system of claim 9, further comprising:
a display for displaying the at least one optimum route to an operating user.

11. The system of claim 9, further comprising:
a database for storing a plurality of travel routes associated with operation of the vehicle.

12. The system of claim 11, wherein the routing intelligence unit is further configured to analyze the plurality of travel routes d to determine at least one travel pattern having common characteristics of associated travel information.

13. The system of claim 12, wherein a plurality of possible travel routes are determined for the predicted travel destination.

14. The system of claim 13, wherein an estimated cost of travel for each of the plurality of possible travel routes is calculated based on the obtained vehicle sensor information.

15. The system of claim 13, wherein the optimum route of travel is calculated based on based on the cost of travel and an estimated time to the predicted destination from the current location.

16. A non-transitory computer readable storage medium having stored executable instructions, that when executed by a processor, causes the processor to:
determine a current location of the vehicle;
analyze the plurality of travel routes to determine at least one travel pattern, wherein the at least one travel pattern includes common characteristics of travel;
predict a destination location based on the current location of the vehicle and stored location information including current time and day information and the common characteristics of the travel pattern.
obtain sensor information associated with vehicle; and
calculate an optimum route of travel based on the obtained vehicle sensor information and a distance between the current location and the predicted destination.

17. The computer readable storage medium of claim 16, wherein the executable instructions further cause the processor to:
determine a plurality of possible travel routes for the predicted destination.

18. The computer readable storage medium of claim 17, wherein the executable instructions further cause the processor to:
obtain sensor information associated with the environment at the current location, the predicted destination, and along the plurality of possible travel routes.

19. The computer readable storage medium of claim 18, wherein the executable instructions further cause the processor to:
calculate a cost of travel for each of the plurality of possible travel routes based on the obtained vehicle sensor information;
categorize the plurality of possible travel routes based on the cost of travel and an estimated time to the predicted destination from the current location.

20. The computer readable storage medium of claim 17, wherein the executable instructions further cause the processor to:
obtain shopping basket information from an operating user, wherein the shopping basket includes at least on shopping item; and
identify at least one retail store associated with the at least one shopping item; and
recalculate the optimum travel route based on a cost associated with shopping item and a cost of travel from the current location to the retail store associated with said shopping item.
